(19) United States
(12) Patent Application Publication
(10) Pub. No.: US 2026/0357847 A1
(43) Pub. Date: Nov. 12, 2026

(54) T-SHAPED WASHER, SECURING STRUCTURE INCLUDING THE SAME, AND FUEL CELL INCLUDING THE STRUCTURE

(71) Applicants: Hyundai Motor Company, Seoul (KR); Kia Corporation, Seoul (KR)

(72) Inventor: Jae Bum LIM, Hwaseong-Si (KR)

(73) Assignees: Hyundai Motor Company, Seoul (KR); Kia Corporation, Seoul (KR)

(21) Appl. No.: 19/370,352

(22) Filed: Oct. 27, 2025

(30) Foreign Application Priority Data
May 8, 2025 (KR) 10-2025-0059753

(51) Int. Cl. F16B 43/00

(52) U.S. Cl. CPC F16B 43/001

(57) ABSTRACT

A ‘T’-shaped washer, a securing structure including the same, and a fuel cell including the structure, includes a body including a through-hole, a washer head disposed on the top portion of the body, and a protruding portion protruding upward from an upper surface of the washer head and having a planar annular shape surrounding the through-hole. At least part of the protruding portion is plastically deformed to a predetermined extent by an external force applied thereto to form a seal line.

### CROSS-REFERENCE TO RELATED APPLICATION

The present application claims the benefit of Korean Patent Application No. 10-2025-0059753, filed on May 8, 2025, which is incorporated by reference as if fully set forth herein.

### BACKGROUND OF THE PRESENT DISCLOSURE

### Field of the Present Disclosure

The present disclosure relates to a ‘T’-shaped washer, a securing structure including the same, and a fuel cell including the structure.

### Description of Related Art

To secure liquid ingress protection that satisfies international standard specifications for fuel cells, it is necessary to configure fuel cell cases in various forms and to provide flexibility in assembly. Research is underway to address issues related to insufficient sealing between an end plate and each of a manifold block and a side cover in fuel cells.

### BRIEF SUMMARY

Accordingly, various exemplary embodiments are directed to a ‘T’-shaped washer, a securing structure including the same, and a fuel cell including the structure that substantially obviate one or more problems due to limitations and disadvantages of the related art.

Embodiments provide a ‘T’-shaped washer configured for providing excellent liquid ingress protection, a securing structure including the same, and a fuel cell including the structure.

However, the aspects of the present disclosure are not limited to the above-mentioned aspects, and other aspects not mentioned herein will be clearly understood by those skilled in the art from the following description.

Additional advantages, aspects, and features of the present disclosure will be set forth in part in the description which follows and in part will become apparent to those having ordinary skill in the art upon examination of the following or may be learned from practice of the present disclosure. The aspects and other advantages of the present disclosure may be realized and attained by the structure pointed out in the written description and claims hereof as well as the appended drawings.

A ‘T’-shaped washer according to various exemplary embodiments of the present disclosure may include a body including a through-hole, a washer head disposed on the top portion of the body, and a protruding portion protruding upwards from an upper surface of the washer head and including a planar annular shape surrounding the through-hole. At least part of the protruding portion may be plastically deformed to a predetermined extent by an external force applied thereto to form a seal line.

In an exemplary embodiment of the present disclosure, the body may have an internal diameter gradually decreasing in a downward direction and may be elastically deformed by the external force so that the internal diameter increases.

In an exemplary embodiment of the present disclosure, the protruding portion may be plastically deformed so that an external boundary of the seal line extends in a direction away from a central axis of the ‘T’-shaped washer.

In an exemplary embodiment of the present disclosure, the protruding portion may have a cross-sectional shape including at least one step.

In an exemplary embodiment of the present disclosure, the protruding portion may include an internal inclined surface inclined at a first angle with respect to the upper surface of the washer head and an external inclined surface inclined at a second angle greater than the first angle with respect to the upper surface of the washer head. The external inclined surface may form an upwardly protruding shape together with the internal inclined surface.

A securing structure according to another exemplary embodiment of the present disclosure may include a ‘T’-shaped washer configured to be inserted into at least one of a first member or a second member overlapping each other in a first direction and a bolt penetrating the ‘T’-shaped washer to secure the first member and the second member. The ‘T’-shaped washer may include a body including a through-hole, a washer head disposed on the top portion of the body, and a protruding portion protruding upwards from an upper surface of the washer head and including a planar annular shape surrounding the through-hole. At least part of the protruding portion may be plastically deformed to a predetermined extent by an external force applied thereto to form a seal line.

In an exemplary embodiment of the present disclosure, the ‘T’-shaped washer may be formed of a material having yield strength lower than yield strength of each of the bolt and the first member.

In an exemplary embodiment of the present disclosure, the body may have an internal diameter gradually decreasing in a downward direction and may be elastically deformed by the external force so that the internal diameter increases.

In an exemplary embodiment of the present disclosure, the bolt may be a flange bolt including a bolt head and a bolt washer disposed under the bolt head, and at least a portion of a lower surface of the bolt washer may be configured to contact with the protruding portion to form the seal line.

In an exemplary embodiment of the present disclosure, an initial contact area between the protruding portion and the bolt may be determined as follows.

$$\frac{FAF}{YS} > IAR$$

FAF represents axial fastening force of the bolt, YS represents yield strength of the protruding portion, and IAR represents the initial contact area.

In an exemplary embodiment of the present disclosure, the first member may include a first upper portion including a first through-hole and a first receiving recess, wherein the first receiving recess is disposed to surround the first through-hole and to receive and support at least a portion of the washer head, and whether at least a portion of the body is inserted into the first through-hole through which the bolt passes.

In an exemplary embodiment of the present disclosure, the second member may include a second through-hole, which is in fluidical communication with the first through-hole in the first member and through which the bolt passes.

In an exemplary embodiment of the present disclosure, the body may include a lower surface disposed higher than an upper surface of the second member.

In an exemplary embodiment of the present disclosure, the body may include a lower surface disposed lower than the upper surface of the second member. In an exemplary embodiment of the present disclosure, the second member may further include a second upper portion including a second receiving recess disposed to surround the second through-hole and to receive a lower end of the body.

In an exemplary embodiment of the present disclosure, in a non-elastically deformed state of the body, an external diameter of the body may be less than the diameter of the second receiving recess.

In an exemplary embodiment of the present disclosure, the external diameter of the body may be greater than the diameter of the second receiving recess based on the bolt securing the first and second members due to elastic deformation of the body.

In an exemplary embodiment of the present disclosure, based on the bolt securing the first and second members due to elastic deformation of the body, a first width of the bolt in a second direction intersecting the first direction, a second width of a portion of the body located on one side of the through-hole in the second direction, and a diameter of the second receiving recess may be determined as follows.

W1+W2>D2

W1 represents the first width, W2 represents the second width, and D2 represents the diameter of the second receiving recess.

In an exemplary embodiment of the present disclosure, the securing structure may further include a pad disposed between the washer head and the first member and including a third through-hole, through which the body passes.

A fuel cell according to various exemplary embodiments of the present disclosure may include a cell stack including a plurality of unit cells and end plates disposed at respective end portions of each of the unit cells, a manifold block configured to supply hydrogen and air to the cell stack, a side cover configured to supply coolant to the cell stack, a ‘T’-shaped washer inserted into at least one of a first member or a second member, the first member being one of the manifold block and the side cover, the second member being one of the end plates, and a bolt penetrating the ‘T’-shaped washer to secure the first member and the second member. The ‘T’-shaped washer may include a body including a through-hole, a washer head disposed on the top portion of the body, and a protruding portion protruding upwards from an upper surface of the washer head and including a planar annular shape surrounding the through-hole. At least part of the protruding portion may be plastically deformed to a predetermined extent by an external force applied thereto to form a seal line.

A fuel cell according to various exemplary embodiments of the present disclosure may include a cell stack including a plurality of unit cells and first and second end plates disposed at respective end portions of each of the unit cells, a manifold block or a side cover disposed on the first end plate, an enclosure disposed to surround the second end plate and a side portion of the cell stack, a ‘T’-shaped washer inserted into at least one of the first member or the second member, and a bolt penetrating the ‘T’-shaped washer to secure the first member and the second member. The ‘T’-shaped washer may include a body including a through-hole, a washer head disposed on the top portion of the body, and a protruding portion protruding upwards from an upper surface of the washer head and including a planar annular shape surrounding the through-hole. At least part of the protruding portion may be plastically deformed to a predetermined extent by an external force applied thereto to form a seal line. The first member may be the manifold block or the side cover, and the second member may be the first end plate. Alternatively, the first member may be the enclosure, and the second member may be the second end plate.

It is to be understood that the foregoing general description and the following detailed description of the present disclosure are exemplary and explanatory and are intended to provide further explanation of the present disclosure as claimed.

### BRIEF DESCRIPTION OF THE DRAWINGS

The accompanying drawings, which are included to provide a further understanding of the present disclosure and are incorporated in and form a portion of the present application, illustrate embodiment(s) of the present disclosure and together with the description serve to explain the principle of the present disclosure. In the drawings:

FIG. 1A, FIG. 1B, FIG. 1C, and FIG. 1D illustrate a perspective view, a plan view, and side views of a ‘T’-shaped washer according to an exemplary embodiment of the present disclosure;

FIG. 2A, FIG. 2B and FIG. 2C illustrate enlarged cross-sectional views of embodiments of portion A shown in FIG. 1A;

FIG. 3A, FIG. 3B, FIG. 3C, and FIG. 3D illustrate an exploded perspective view, an exploded cross-sectional view, a partially assembled perspective view, and an assembled cross-sectional view of a securing structure according to an exemplary embodiment of the present disclosure, respectively;

FIG. 4A and FIG. 4B illustrate cross-sectional views of the securing structure according to the embodiment;

FIG. 5A, FIG. 5B, and FIG. 5C illustrate plan views and cross-sectional views of a process in which the bolt shown in FIG. 4A is fastened to the ‘T’-shaped washer;

FIG. 6A, FIG. 6B, and FIG. 6C illustrate a perspective view, a front view, and a cross-sectional view of a fuel cell according to an exemplary embodiment of the present disclosure, respectively;

FIG. 6D illustrates an enlarged view of portion B shown in FIG. 6C;

FIG. 6E illustrates a cross-sectional view of another exemplary embodiment taken along line I-I′ in FIG. 6B;

FIG. 7 illustrates a seal line of a fuel cell according to a comparative example;

FIG. 8 illustrates a seal line of the fuel cell according to the embodiment;

FIG. 9 is a graph showing characteristics of the ‘T’-shaped washer according to the embodiment; and

FIG. 10A, FIG. 10B and FIG. 10C illustrate an example of the fastening process in the fuel cell shown in FIG. 6B.

### DETAILED DESCRIPTION OF THE PRESENT DISCLOSURE

The present disclosure will now be described more fully hereinafter with reference to the accompanying drawings, in which various exemplary embodiments of the present disclosure are shown. The examples, however, may be embodied in various forms, and should not be construed as being limited to the exemplary embodiments set forth herein. Rather, these embodiments are provided so that the present disclosure will be more thorough and complete, and will more fully convey the scope of the present disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

Furthermore, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

Hereinafter, a ‘T’-shaped washer 100 (100A or 100B), a securing structure 200 (200A or 200B) including the same, and a fuel cell 300 including the structure according to various exemplary embodiments will be described with reference to the accompanying drawings. The ‘T’-shaped washer 100 (100A or 100B), the securing structure 200 (200A or 200B) including the same, and the fuel cell 300 including the structure will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the exemplary embodiments are not limited thereto. That is, the x-axis, the y-axis, and the z-axis may intersect each other obliquely.

First, a ‘T’-shaped washer 100 according to an exemplary embodiment will be described.

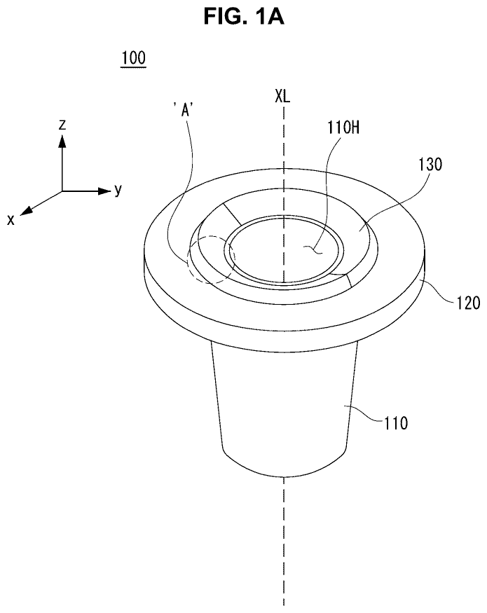

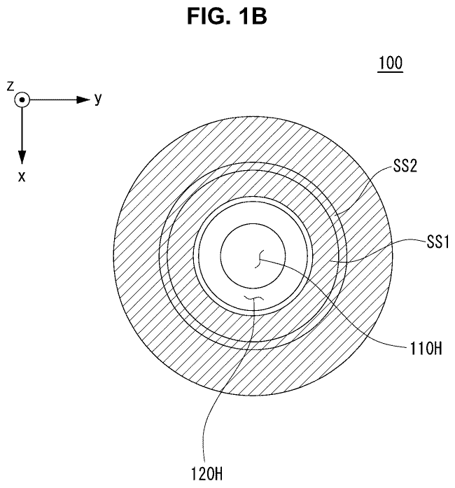

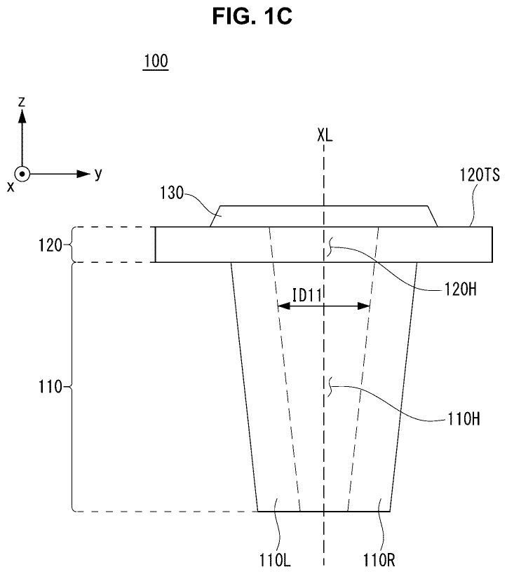

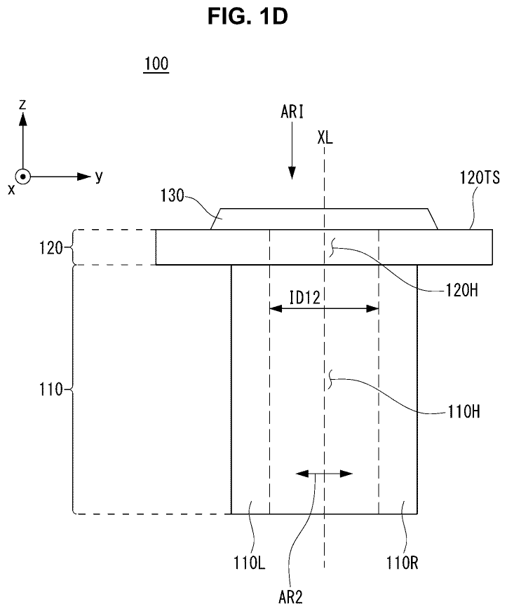

FIG. 1A is a perspective view of a ‘T’-shaped washer 100 according to an exemplary embodiment of the present disclosure, FIG. 1B is a plan view of the ‘T’-shaped washer 100 shown in FIG. 1A, and FIGS. 1C and 1D are side views of the ‘T’-shaped washer 100 shown in FIG. 1A.

According to the exemplary embodiment of the present disclosure, the ‘T’-shaped washer 100 includes a body 110, a head (hereinafter referred to as a “washer head”) 120, and a protruding portion 130.

The body 110 includes a through-hole (hereinafter referred to as a “first through-hole”) 110H. In FIGS. 1C and 1D, the first through-hole 110H, which is not visible from the outside thereof, is indicated by dotted lines to aid in understanding.

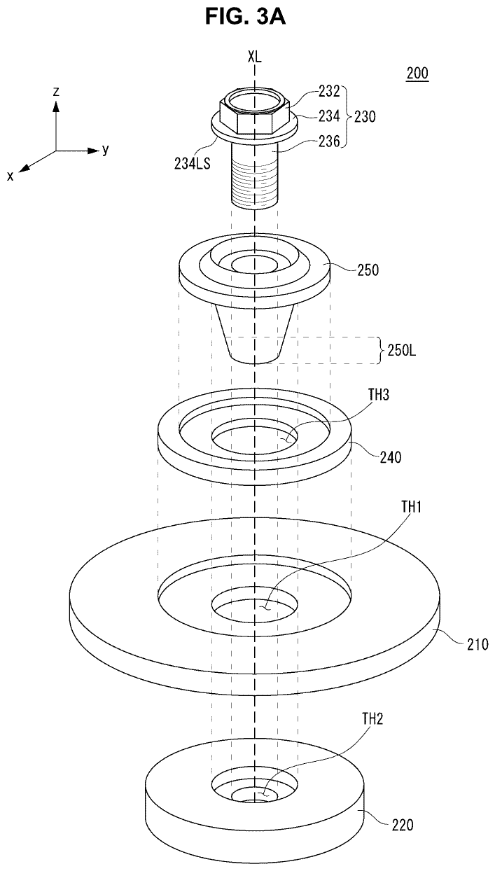

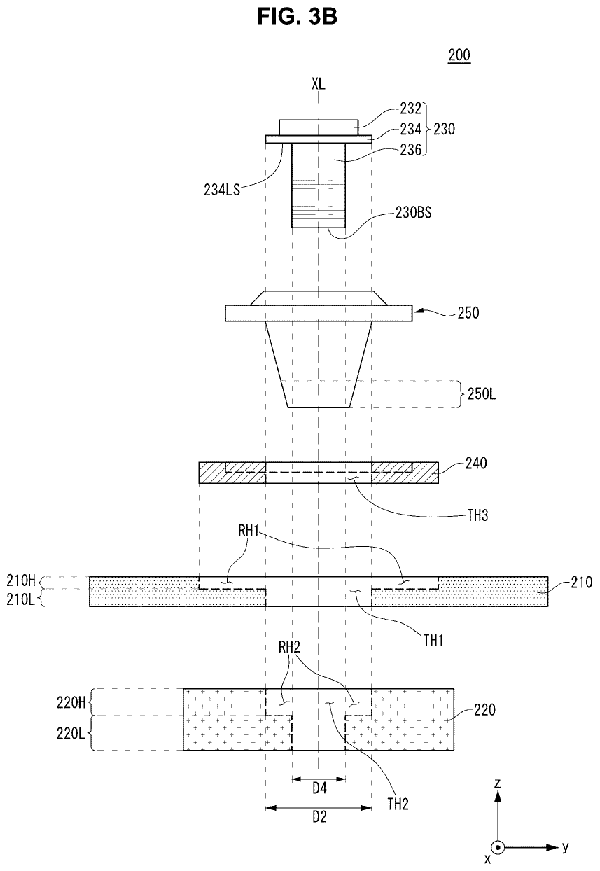

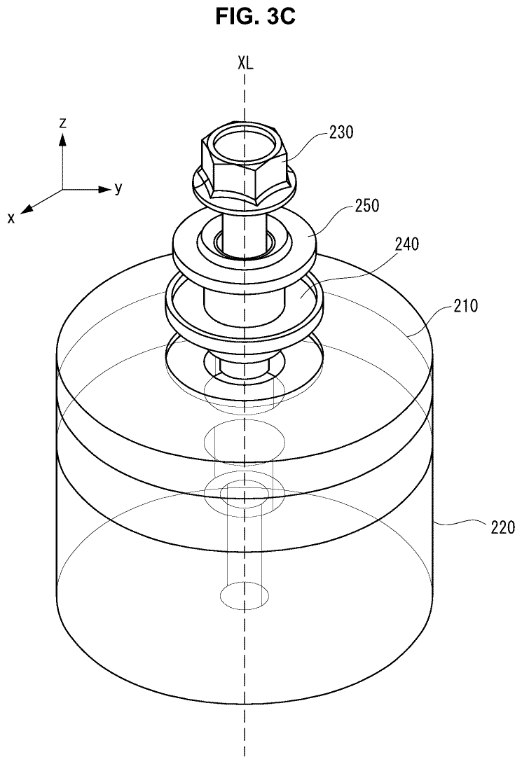

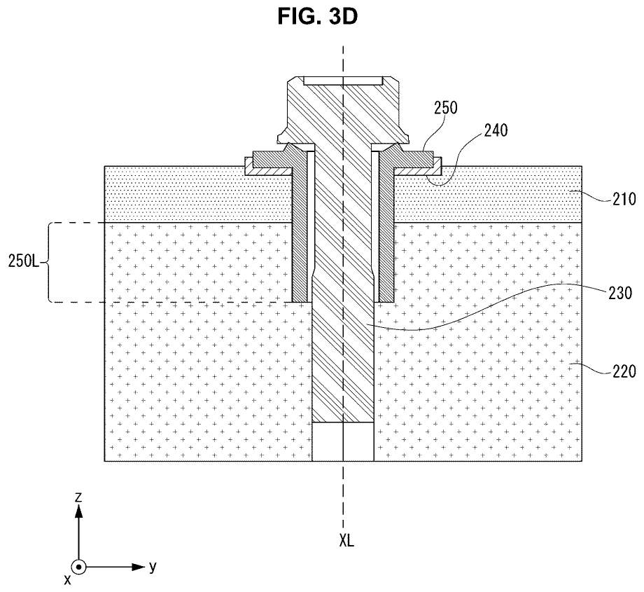

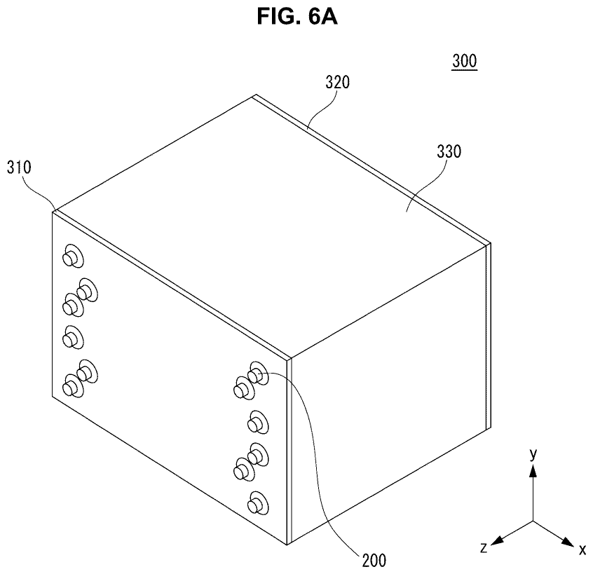

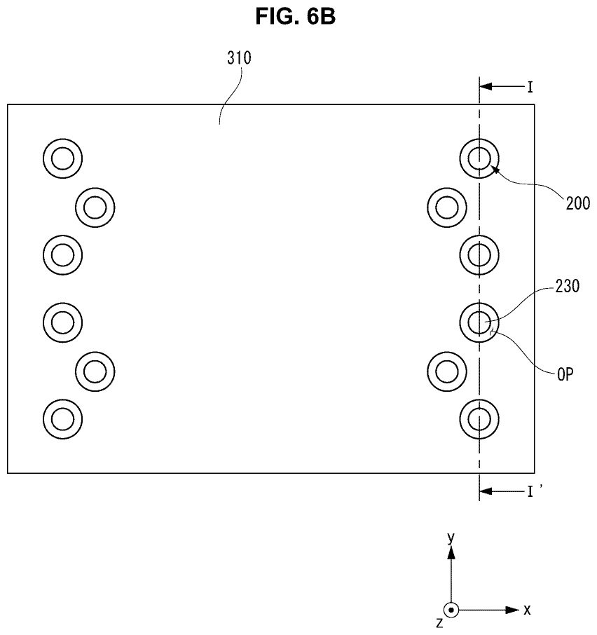

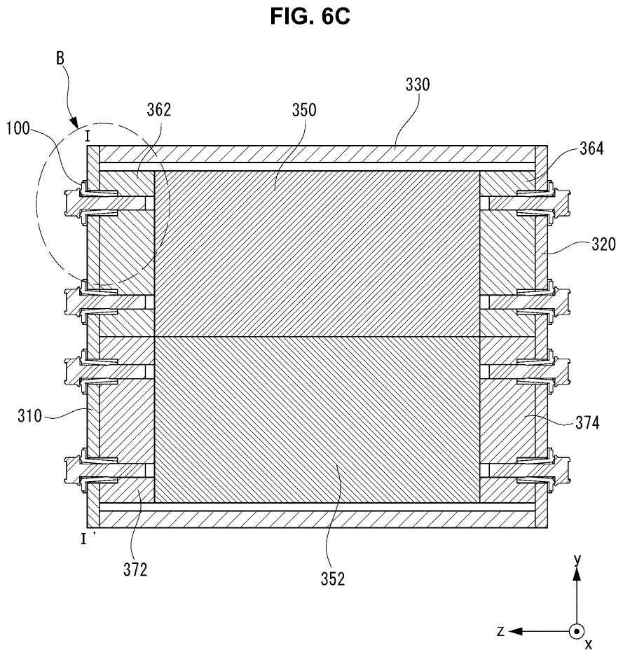

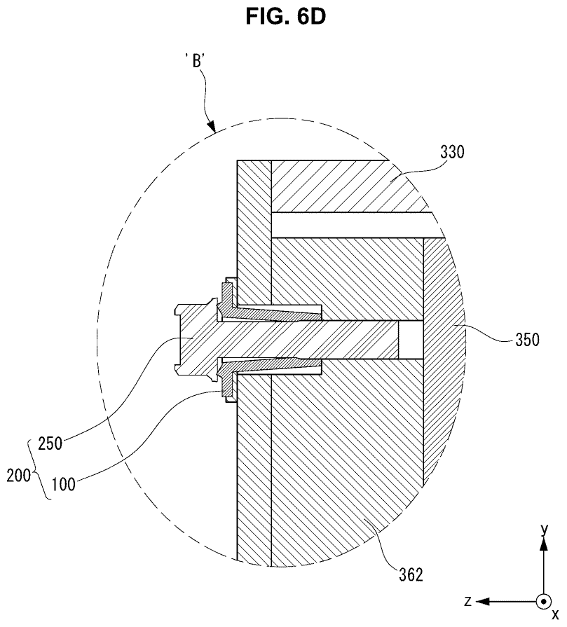

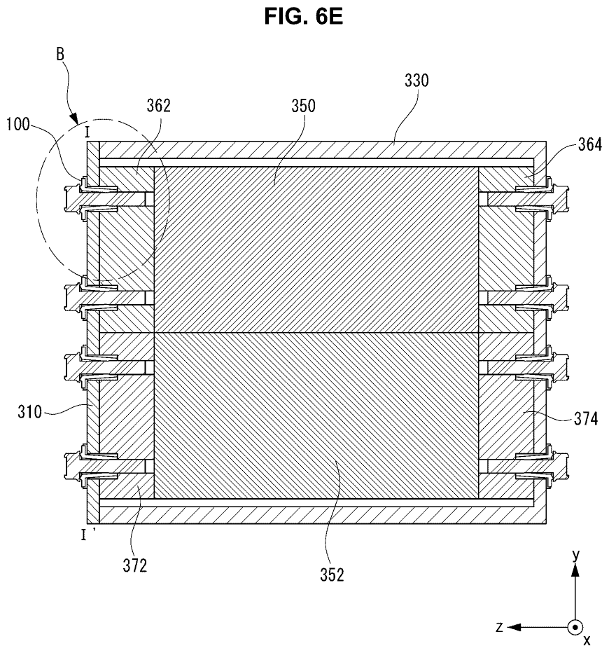

The body 110 may have an internal diameter ID11 that gradually decreases in a downward direction (i.e., the −z-axis direction) and may be elastically deformed by external force so that the internal diameter thereof increases. For example, as the internal diameter ID11 shown in FIG. 1C increases under external force, the body 110 may be elastically deformed into a cylindrical shape having a constant internal diameter ID12, as shown in FIG. 1D or FIG. 3D, which will be described later. Alternatively, without necessarily becoming completely cylindrical, the body 110 may be elastically deformed by external force so that the internal diameter ID11, which gradually decreases toward a lower side of the body 110 as shown in FIG. 1C, increases to the extent illustrated in FIG. 6D.

If no external force is applied to the ‘T’-shaped washer 100 in the direction of arrow AR1 shown in FIG. 1D, the internal diameter ID11 of the first through-hole 110H in the body 110 gradually decreases in the downward direction, as shown in FIG. 1C. That is, the body 110 includes a wedge shape. However, as shown in FIG. 1D, if external force is applied to the ‘T’-shaped washer 100 in the direction of arrow AR1, the first through-hole 110H may be elastically deformed in the direction of arrow AR2, and the body 110 may be deformed into a cylindrical shape having a constant internal diameter ID12.

For example, the external force applied to the body 110 may be force by which a bolt 230, which will be described later, is fastened to the ‘T’-shaped washer 100.

The washer head 120 is disposed on the top portion of the body 110 and includes a through-hole (hereinafter referred to as a “second through-hole”) 120H that is in fluidical communication with the first through-hole 110H.

The protruding portion 130 protrudes upward (i.e., in the z-axis direction) from an upper surface 120TS of the washer head 120 and has a planar annular shape that surrounds a central axis XL of the ‘T’-shaped washer 100 (or the first or second through-hole 110H or 120H). For example, the planar annular shape of the protruding portion 130 is a completely closed loop.

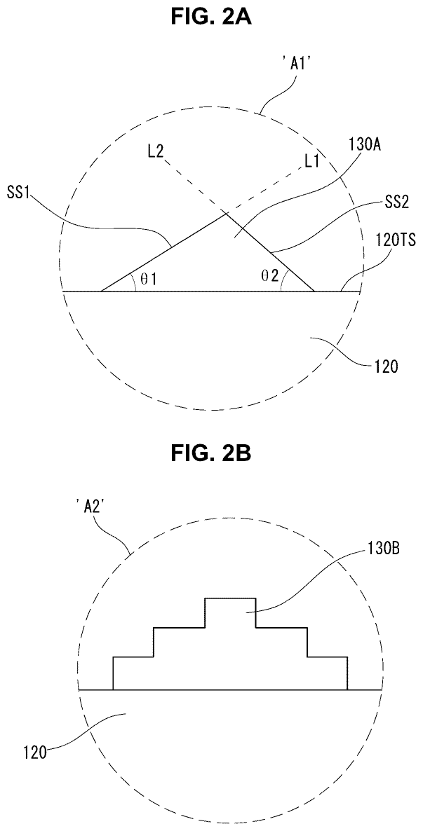

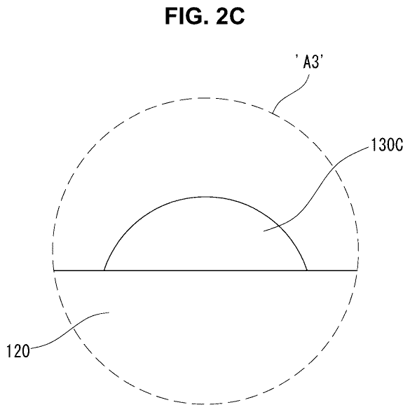

FIG. 2A is an enlarged cross-sectional view of an exemplary embodiment A1 of portion A shown in FIG. 1A, FIG. 2B is an enlarged cross-sectional view of another exemplary embodiment A2 of portion A shown in FIG. 1A, and FIG. 2C is an enlarged cross-sectional view of various exemplary embodiments A3 of portion A shown in FIG. 1A.

According to an exemplary embodiment of the present disclosure, the protruding portion 130A may have an inclined cross-sectional shape. For example, as shown in FIG. 2A, the protruding portion 130A may include an internal inclined surface SS1 inclined inward and an external inclined surface SS2 inclined outward.

The internal inclined surface SS1 has a cross-sectional shape inclined at a first angle θ1 with respect to the upper surface 120TS of the washer head 120, and the external inclined surface SS2 has a cross-sectional shape inclined at a second angle θ2 greater than the first angle θ1 with respect to the upper surface 120TS of the washer head 120. The internal inclined surface SS1 is located on an internal side of the protruding portion 130A facing the central axis XL (or the second through-hole 120H), and the external inclined surface SS2 is located on an external side of the protruding portion 130A.

As shown, the external inclined surface SS2 may protrude upward together with the internal inclined surface SS1 to form the protruding shape of the protruding portion 130A.

According to another exemplary embodiment of the present disclosure, the protruding portion 130B may include a cross-sectional shape including at least one step. For example, as shown in FIG. 2B, the protruding portion 130B may have a cross-sectional shape including a plurality of steps.

According to various exemplary embodiments of the present disclosure, as shown in FIG. 2C, the protruding portion 130C may have a cross-sectional shape protruding in a semi-circular form.

As shown in FIG. 2A, FIG. 2B and FIG. 2C, the protruding portion 130 may have various cross-sectional shapes. However, the exemplary embodiments are not limited to any specific cross-sectional shape of the protruding portion 130.

Hereinafter, for convenience of description, the protruding portion 130 will be described as having the cross-sectional shape shown in FIG. 2A. However, the following description may also be applied to a configuration in which the protruding portion 130 has a cross-sectional shape different from that shown in FIG. 2A.

Next, a securing structure 200 including the ‘T’-shaped washer 100 according to an exemplary embodiment will be described.

FIG. 3A is an exploded perspective view of a securing structure 200 according to an exemplary embodiment of the present disclosure, FIG. 3B is an exploded cross-sectional view of the securing structure 200 shown in FIG. 3A, FIG. 3C is a partially assembled perspective view of the securing structure 200 shown in FIG. 3A, and FIG. 3D is an assembled cross-sectional view of the securing structure 200 shown in FIG. 3A.

The securing structure 200 according to the exemplary embodiment of the present disclosure may include a bolt 230 and a ‘T’-shaped washer 250. Furthermore, the securing structure 200 may further include a pad 240.

A first member 210 and a second member 220 are disposed to overlap each other in a first direction (i.e., the z-axis direction). The first member 210 and the second member 220 are members that are required to be joined together. The exemplary embodiments are not limited to any specific type of the first member 210 or the second member 220.

The ‘T’-shaped washer 250 is inserted into and disposed in at least one of the first member 210 or the second member 220. Because the ‘T’-shaped washer 250 corresponds to the above-described ‘T’-shaped washer 100, redundant descriptions thereof will be omitted.

Hereinafter, for convenience of description, the securing structure 200 will be described as including the ‘T’-shaped washer 100 shown in FIG. 1A, FIG. 1B, FIG. 1C, and FIGS. 1D and 2A. However, the following description may also be applied to a configuration in which the ‘T’-shaped washer 250 having the form shown in FIG. 2B or 2C is used.

The bolt 230 is configured to secure the first member 210 and the second member 220 by passing through the ‘T’-shaped washer 250.

According to the exemplary embodiment of the present disclosure, the bolt 230 may be a flange bolt. The flange bolt 230 may include a head (hereinafter referred to as a “bolt head”) 232, a washer (hereinafter referred to as a “bolt washer”) 234, and a threaded portion 236. For example, as shown in FIG. 3A, the bolt head 232 may include a hexagonal side surface. However, the embodiments are not limited to any specific shape of the bolt head 232.

The bolt washer 234 is disposed under the bolt head 232. According to the exemplary embodiment of the present disclosure, the bolt washer 234 is configured to apply external force to the protruding portion 130 of the ‘T’-shaped washer 250 in the direction of arrow AR1, as shown in FIG. 1D.

The pad 240 may be disposed between the washer head 120 and the first member 210 and may include a third through-hole TH3 through which the body 110 of the ‘T’-shaped washer 100 passes.

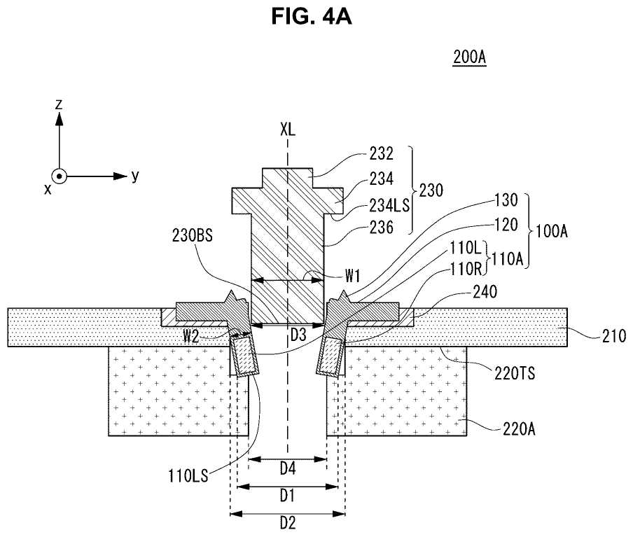

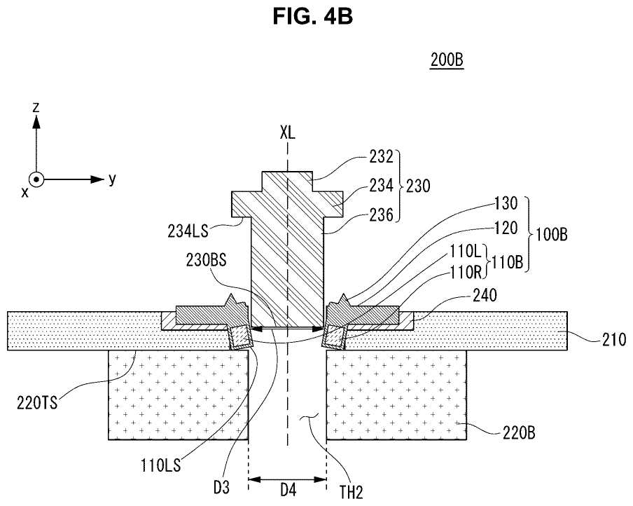

FIG. 4A is a cross-sectional view of a securing structure 200A according to an exemplary embodiment of the present disclosure, and FIG. 4B is a cross-sectional view of a securing structure 200B according to another exemplary embodiment of the present disclosure.

FIG. 4A shows the cross-section of the securing structure 200A immediately before a bolt 230 applies external force to a ‘T’-shaped washer 100A, and FIG. 4B shows the cross-section of the securing structure 200B immediately before a bolt 230 applies external force to a ‘T’-shaped washer 100B.

The securing structure 200A shown in FIG. 4A includes a bolt 230, a pad 240, and a ‘T’-shaped washer 100A. The first member 210, the second member 220A, the bolt 230, the pad 240, and the ‘T’-shaped washer 100A correspond to and perform the same functions as the first member 210, the second member 220, the bolt 230, the pad 240, and the ‘T’-shaped washer 250 shown in FIG. 3A, FIG. 3B, FIG. 3C, and FIG. 3D, respectively.

The securing structure 200B shown in FIG. 4B includes a bolt 230, a pad 240, and a ‘T’-shaped washer 100B. The first member 210, the second member 220B, the bolt 230, the pad 240, and the ‘T’-shaped washer 100B correspond to and perform the same functions as the first member 210, the second member 220, the bolt 230, the pad 240, and the ‘T’-shaped washer 250 shown in FIG. 3A, FIG. 3B, FIG. 3C, and FIG. 3D, respectively. However, the second member 220B and the ‘T’-shaped washer 100B of the securing structure 200B shown in FIG. 4B have different shapes from the second member 220 and the ‘T’-shaped washer 250 of the securing structure 200 shown in FIG. 3A, FIG. 3B, FIG. 3C, and FIG. 3D, respectively.

In the securing structures 200A and 200B according to the embodiments, the first member 210 includes a first upper portion 210H and a first lower portion 210L, as shown in FIG. 3A and FIG. 3B. The first upper portion 210H includes a first receiving recess RH1 and a first through-hole TH1.

The first through-hole TH1 is a portion through which the bolt 230 and the ‘T’-shaped washer 250 pass. The first receiving recess RH1 is disposed to surround the first through-hole TH1 and is configured to receive and support at least a portion of the washer head 120. The first lower portion 210L is disposed under the first upper portion 210H and includes the first through-hole TH1.

The second member 220 includes a second receiving recess RH2 and a second through-hole TH2. The second through-hole TH2 is in fluidical communication with the first through-hole TH1, and the bolt 230 passes through the second through-hole TH2. The second receiving recess RH2 is disposed to surround the second through-hole TH2 and is configured to receive a lower end 250L of the body 110A. In the second member 220, a second lower portion 220L is disposed under a second upper portion 220H and includes the second through-hole TH2.

In the securing structure 200A shown in FIG. 4A, a lower surface 110LS of the body 110A is disposed lower than an upper surface 220TS of the second member 220A. in the present structure, as described above, the second member 220A may include the second upper portion 220H and the second lower portion 220L.

In the securing structure 200B shown in FIG. 4B, a lower surface 110LS of the body 110B is disposed higher than an upper surface 220TS of the second member 220B. The body 110B shown in FIG. 4B is disposed to be shorter in the first direction than the body 110A shown in FIG. 4A. Unlike the second member 220A shown in FIG. 4A, the second member 220B shown in FIG. 4B does not include the second receiving recess RH2. Thus, the ‘T’-shaped washer 100A shown in FIG. 4A is inserted into the first and second members 210 and 220A, whereas the ‘T’-shaped washer 100B shown in FIG. 4B is inserted into the first member 210 but not into the second member 220B. With the present exception, the securing structure 200B shown in FIG. 4B has the same configuration as the securing structure 200A shown in FIG. 4A. Therefore, for the same configuration, the following description of the securing structure 200A shown in FIG. 4A may also be applied to the securing structure 200B shown in FIG. 4B.

In a state in which the body 110A is not elastically deformed, that is, before the bolt 230 secures the first and second members 210 and 220A, an external diameter D1 of the body 110A may be less than a diameter D2 of the second receiving recess RH2.

In a state in which the body 110A is elastically deformed and the bolt 230 secures the first and second members 210 and 220A, the external diameter D1 of the body 110A may be greater than the diameter D2 of the second receiving recess RH2, as expressed by Equation 1 below.

D1>D2 [Equation 1]

In a state in which the body 110A is elastically deformed and the bolt 230 secures the first and second members 210 and 220A, a first width W1 of the bolt 230 in a second direction intersecting the first direction, a second width W2 of a portion 110L or 110R of the body (hereinafter referred to as a “guide portion”) located on one side of the through-hole 110H in the second direction, and the diameter D2 of the second receiving recess RH2 have the relationship expressed by Equation 2 below.

W1+W2>D2 [Equation 2]

If at least one of Equation 1 or Equation 2 is satisfied, the bolt 230 may be inserted into the first and second through-holes TH1 and TH2 in a press-fit manner to secure the first and second members 210 and 220A.

As the bolt 230 is inserted into the through-hole 110H, the body 110A is elastically deformed due to external force applied thereto. When the bolt 230 begins to apply external force to the body 110A, as shown in FIG. 4A, an internal diameter D3 of a portion of the body 110A (i.e., a distance between the guide portions 110L and 110R in the second direction), with which a lower surface 230BS of the threaded portion 236 of the bolt 230 comes into contact, may become equal to an internal diameter D4 of the second lower portion 220L of the second member 220A, that is, the width of the second through-hole TH2 in the second direction. Accordingly, the guide portions 110L and 110R may guide the travel path of the bolt 230 inserted into the through-hole 110H, thereby allowing the bolt 230 to be linearly fastened along the central axis XL.

When the bolt 230 is inserted into the ‘T’-shaped washer 100 (100A, 100B, or 250) to secure the first and second members 210 and 220A, at least part of the protruding portion 130 may be plastically deformed to a predetermined extent due to external force, thereby forming a seal line SL. To the present end, at least a portion of the lower surface 234LS of the bolt washer 234 may come into contact with the protruding portion 130 to form the seal line.

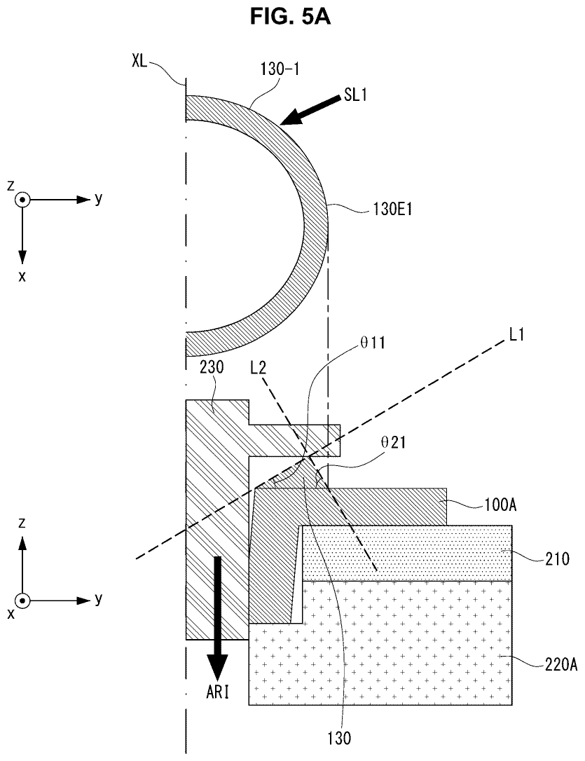

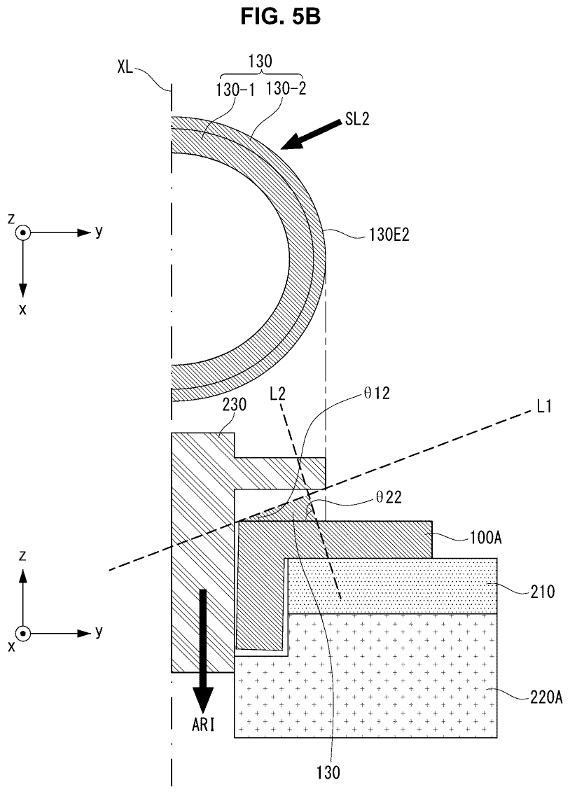

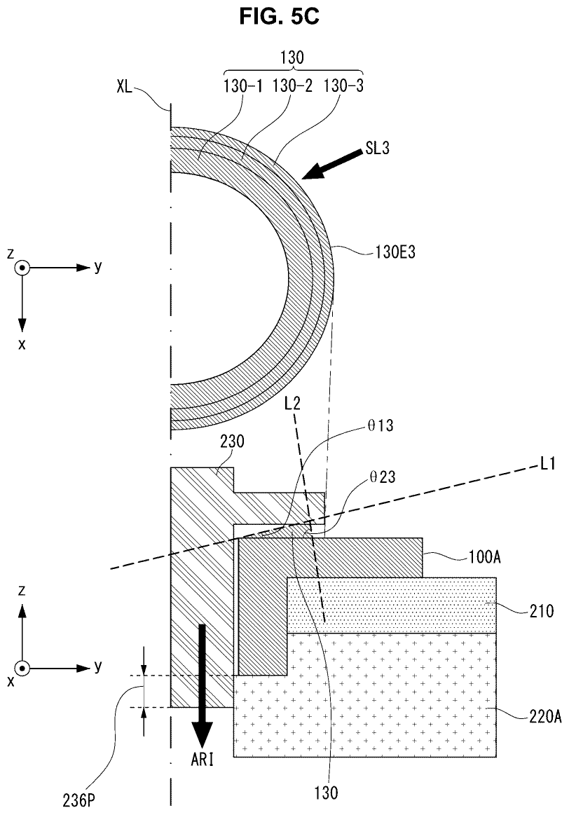

FIG. 5A illustrates a plan view and a cross-sectional view of the securing structure at the initial stage in which the bolt 230 shown in FIG. 4A is fastened to the ‘T’-shaped washer 100A. FIG. 5B illustrates a plan view and a cross-sectional view of the securing structure during the fastening of the bolt 230 to the ‘T’-shaped washer 100A. FIG. 5C illustrates a plan view and a cross-sectional view of the securing structure after the bolt 230 is completely fastened to the ‘T’-shaped washer 100A.

The securing structure 200A according to the exemplary embodiment of the present disclosure may have a bilaterally symmetrical cross-sectional shape with respect to the central axis XL. Accordingly, although the right side with respect to the central axis XL shown in FIG. 4A is shown in FIG. 5A, FIG. 5B, and FIG. 5C, the left side with respect to the central axis XL has a shape symmetrical to that shown in FIG. 5A, FIG. 5B, and FIG. 5C.

Referring to FIG. 5A, when the bolt 230 is inserted into the through-hole 110H in the direction of arrow AR1, the lower surface 234LS of the bolt washer 234 presses the protruding portion 130.

Subsequently, as shown in FIG. 5B, as the bolt 230 is further inserted into the through-hole 110H in the direction of arrow AR1, the bolt washer 234 further presses the protruding portion 130, and at least part of the protruding portion 130 is plastically deformed. For example, the first angle θ12 shown in FIG. 5B becomes less than the first angle θ11 shown in FIG. 5A, whereas the second angle θ22 shown in FIG. 5B becomes greater than the second angle θ21 shown in FIG. 5A.

Subsequently, as shown in FIG. 5C, as the bolt 230 is inserted even further into the through-hole 110H in the direction of arrow AR1, the bolt washer 234 presses even further the protruding portion 130, and at least part of the protruding portion 130 continues to undergo plastic deformation. For example, the first angle θ13 shown in FIG. 5C becomes less than the first angle θ12 shown in FIG. 5B, whereas the second angle θ23 shown in FIG. 5C becomes greater than the second angle θ22 shown in FIG. 5B.

That is, as the fastening proceeds, an imaginary first line segment L1 parallel to the internal inclined surface SS1 rotates in the clockwise direction, and an imaginary second line segment L2 parallel to the external inclined surface SS2 also rotates in the clockwise direction.

When the axial fastening force becomes equal to the yield strength of the material of the protruding portion 130, the bolt 230 is no longer inserted in the direction of arrow AR1.

For the bolt 230 and the first member 210 to remain in an elastic region while at least a portion of the ‘T’-shaped washer 100A, that is, the protruding portion 130, is partially in a plastic region, the ‘T’-shaped washer 100A may be formed of a material having yield strength lower than that of each of the bolt 230 and the first member 210.

According to the exemplary embodiment of the present disclosure, as part of the protruding portion 130 is plastically deformed, the seal line 130 may increase in size while being deformed from the seal line SL1 (130-1) shown in FIG. 5A to the seal line SL3 (130-1 to 130-3) shown in FIG. 5C via the seal line SL2 (130-1 and 130-2) shown in FIG. 5B. As such, the protruding portion 130 may expand due to plastic deformation so that an external boundary 130E1 of the seal line 130-1 extends in a direction away from the central axis XL to reach a boundary 130E3.

An initial contact area between the protruding portion 130 and the bolt 230 for the above-described plastic deformation of part of the protruding portion 130 may be set as defined by Equation 3 below.

$$\frac{FAF}{YS} > IAR \qquad [ Equation 3 ]$$

In Equation 3, FAF represents the axial fastening force of the bolt 230, YS represents the yield strength of the protruding portion 130, and IAR represents the initial contact area between the protruding portion 130 and the bolt 230.

The exemplary embodiments are not limited to any specific location at which threads are disposed on the threaded portion 236. For example, the threads may be disposed over the entire area of threaded portion 236 or may be disposed on an end portion 236P of the threaded portion 236 shown in FIG. 5C.

Hereinafter, a fuel cell 300 including the securing structure 200 according to an exemplary embodiment will be described.

FIG. 6A is a perspective view of a fuel cell 300 according to an exemplary embodiment of the present disclosure, FIG. 6B is a front view of the fuel cell 300 shown in FIG. 6A, FIG. 6C is a cross-sectional view of an exemplary embodiment taken along line I-I′ in FIG. 6B, FIG. 6D is an enlarged view of portion B shown in FIG. 6C, and FIG. 6E is a cross-sectional view of another exemplary embodiment taken along line I-I′ in FIG. 6B.

As shown in FIG. 6A, FIG. 6B, FIG. 6C, and FIG. 6D, the fuel cell 300 according to the exemplary embodiment of the present disclosure includes cell stacks 350 and 352, a side cover 310, a manifold block 320, an enclosure 330, end plates (pressing plates or compression plates) 362, 364, 372, and 374, and a securing structure 200.

The fuel cell 300 may include a single unit fuel cell or may include a plurality of unit fuel cells stacked in at least one of a vertical direction or a horizontal direction. For example, as shown in FIG. 6C, the fuel cell 300 may include an upper unit fuel cell and a lower unit fuel cell stacked in the vertical direction. Hereinafter, the fuel cell 300 will be described as including two unit fuel cells. However, the following description may also be applied to a configuration in which the fuel cell 300 includes a single unit fuel cell.

Each of the plurality of unit fuel cells may be a polymer electrolyte membrane fuel cell (or a proton exchange membrane fuel cell) (PEMFC), which has been studied most extensively as a power source for driving vehicles including the fuel cell 300 (hereinafter referred to as “fuel cell vehicles”). However, the exemplary embodiments are not limited to any specific form, configuration, or appearance of the unit fuel cell.

The upper unit fuel cell may include first and second upper end plates 362 and 364, upper current collectors, and an upper cell stack 350, and the lower unit fuel cell may include first and second lower end plates 372 and 374, lower current collectors, and a lower cell stack 352.

Each of the upper and lower cell stacks 350 and 352 may include a plurality of unit cells stacked in the horizontal direction. Tens to hundreds of unit cells, for example, 100 to 400 unit cells, may be stacked to form the cell stack. The number of unit fuel cells included in the fuel cell 300 and the number of unit cells included in the cell stacks 350 and 352 of the unit fuel cell may be determined depending on the intensity of power to be supplied from the fuel cell 300 to a load. For example, the load may be a part that requires power in fuel cell vehicles or the like.

The first and second upper end plates 362 and 364 may be disposed at respective end portions of the upper cell stack 350 and may support and fix the plurality of unit cells. The first and second lower end plates 372 and 374 may be disposed at respective end portions of the lower cell stack 352 and may support and fix the plurality of unit cells. That is, the first upper end plate 362 may be disposed at one of the two opposite end portions of the upper cell stack 350, and the second upper end plate 364 may be disposed at the other of the two opposite end portions of the upper cell stack 350. The first lower end plate 372 may be disposed at one of the two opposite end portions of the lower cell stack 352, and the second lower end plate 374 may be disposed at the other of the two opposite end portions of the lower cell stack 352.

The upper current collectors may be disposed between the upper cell stack 350 and the internal surfaces of the first and second upper end plates 362 and 364 that face the upper cell stack 350, and the lower current collectors may be disposed between the lower cell stack 352 and the internal surfaces of the first and second lower end plates 372 and 374 that face the lower cell stack 352. Each of the upper and lower current collectors is configured to collect electrical energy generated by the flow of electrons in a corresponding one of the upper and lower cell stacks 350 and 352 and to supply the electrical energy to a load of a fuel cell vehicle.

According to an exemplary embodiment of the present disclosure, the enclosure 330 may be a four-sided enclosure that surrounds side portions of the upper and lower cell stacks 350 and 352 and includes a first opening that exposes one end of each of the upper and lower cell stacks 350 and 352 and a second opening that exposes the other end of each of the upper and lower cell stacks 350 and 352. For example, the first upper and first lower end plates 362 and 372 may be disposed in the first opening in the enclosure 330, and the second upper and second lower end plates 364 and 374 may be disposed in the second opening in the enclosure 330.

According to another exemplary embodiment of the present disclosure, the enclosure 330 may be a five-sided enclosure that surrounds not only side portions of the upper and lower cell stacks 350 and 352 but also one end of each of the upper and lower cell stacks 350 and 352 and includes an opening that exposes the other end of each of the upper and lower cell stacks 350 and 352. For example, the first upper and first lower end plates 362 and 372 or the second upper and second lower end plates 364 and 374 may be disposed in the opening. In an exemplary embodiment of the present disclosure, as shown in FIG. 6E, the first upper and first lower end plates 362 and 372 may be disposed in the opening.

The enclosure 330 may be formed of a metallic material.

The manifold block 310 is configured to supply hydrogen and air to the upper and lower cell stacks 350 and 352, and the side cover 320 is configured to supply coolant to the upper and lower cell stacks 350 and 352.

According to an exemplary embodiment of the present disclosure, one of the manifold block 310 and the side cover 320 may correspond to the above-described first member 210, and the first and second upper and lower end plates 362, 364, 372, and 374 may correspond to the above-described second member 220 (220A or 220B). For example, as shown in FIG. 6C, the manifold block 310 may correspond to the first member 210, the first upper and first lower end plates 362 and 372 may correspond to the second member 220 (220A or 220B), the side cover 320 may correspond to the first member 210, and the second upper and second lower end plates 364 and 374 may correspond to the second member 220 (220A or 220B).

According to another exemplary embodiment of the present disclosure, the enclosure 330 may correspond to the above-described first member 210, and the first upper and first lower end plates 362 and 372 or the second upper and second lower end plates 364 and 374 may correspond to the above-described second member 220 (220A or 220B). For example, as shown in FIG. 6E, the enclosure 330 may correspond to the first member 210, and the second upper and second lower end plates 364 and 374 may correspond to the second member 220 (220A or 220B).

Therefore, in the fuel cell 300 according to the exemplary embodiment of the present disclosure, the ‘T’-shaped washer 100 (100A or 100B) may be inserted into at least one of the first member 210 or the second member 220A or 220B, and the bolt 250 may secure the first member 210 and the second member 220A or 220B by passing through the ‘T’-shaped washer 100 (100A or 100B).

For example, as shown in FIGS. 6C and 6D, the ‘T’-shaped washer 100 may be inserted into the manifold block 310 and the side cover 320, and the bolt 250 may pass through the ‘T’-shaped washer 100, thereby securing the manifold block 310 and the first upper and first lower end plates 362 and 372 and securing the side cover 320 and the second upper and second lower end plates 364 and 374.

Hereinafter, the securing structure and the fuel cell according to the exemplary embodiments will be described in comparison with those of a comparative example.

In a fuel cell according to a comparative example, a bolt may be used to secure an end plate as a second member and a side cover as a first member or to secure a manifold block as a first member and an end plate as a second member. However, because a seal line is not disposed between the secured component, such as the end plate, the side cover, or the manifold block, and the seating surface of the bolt, the fuel cell may be vulnerable to liquid ingress. As a result, the liquid ingress protection of the fuel cell may deteriorate.

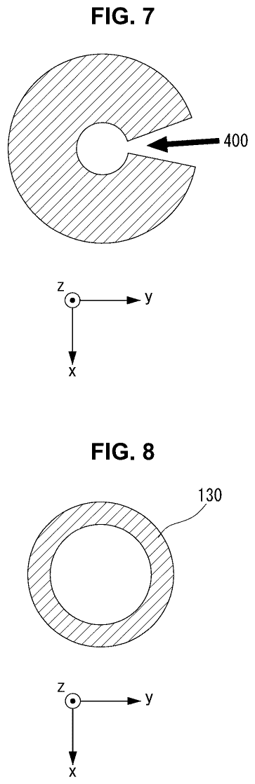

FIG. 7 is a view showing a seal line of the fuel cell according to the comparative example, and FIG. 8 is a view showing a seal line of the fuel cell according to the exemplary embodiment of the present disclosure.

In a fuel cell, when a bolt is fastened inside a gasket line, an O-ring or a seal lock may be used to improve liquid ingress protection. However, in the comparative example, there may be insufficient space to place the O-ring, and the O-ring may become detached or torn. Accordingly, as shown in FIG. 7, the seal line may be wide, and may not include a closed-loop shape due to the presence of a leakage point 400.

Furthermore, in the comparative example using a seal lock, the seal lock may enter the cell stack of the fuel cell, and may function as foreign matter that contaminates the cell stack or damages components. Furthermore, in the comparative example, the O-ring or the seal lock may make it impossible to re-secure or repeatedly secure the first member and the second member.

Furthermore, due to the characteristics of the fuel cell of the comparative example in which the component to be secured is large in size and includes a large number of fastening points, the alignment accuracy of a plurality of bolts fastened to the component may be low, resulting in reduction in fastening force. Furthermore, it may be difficult to simultaneously fasten the plurality of bolts using a robot or the like, which may lead to increase in capital investment and manufacturing cost.

In contrast, according to the exemplary embodiment of the present disclosure, by inducing plastic deformation in at least part of the protruding portion 130 of the ‘T’-shaped washer 100 (100A, 100B, or 250) to independently form a seal line, the protruding portion 130 of the ‘T’-shaped washer may have a narrow, continuous annular shape, as shown in FIG. 8. As a result, the protruding portion 130 of the ‘T’-shaped washer may have a closed-loop shape without the leakage point 400, thereby enhancing watertightness and improving liquid ingress protection.

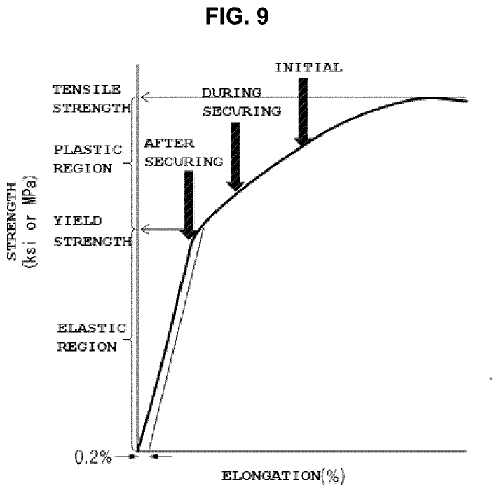

FIG. 9 is a graph showing characteristics of the ‘T’-shaped washer 100 (100A, 100B, or 250) according to the exemplary embodiment of the present disclosure.

In FIG. 9, the term “INITIAL” represents the initial stage in which the first and second members 210 and 220A are secured using the bolt 230, as shown in FIG. 5A. The term “DURING SECURING” represents a state in which the process of securing the first and second members 210 and 220A using the bolt 230 is underway, as shown in FIG. 5B. The term “AFTER SECURING” represents a state in which the first and second members 210 and 220A have been completely secured using the bolt 230, as shown in FIG. 5C.

Referring to FIG. 9, the protruding portion 130 is in a plastic deformation region from the “INITIAL” to the “AFTER SECURING”, and the fastening of the bolt is completed at a boundary point between the plastic deformation region and the elastic deformation region. According to the exemplary embodiment of the present disclosure, in the ‘T’-shaped washer 100A, portion of the protruding portion 130 is plastically deformed to a predetermined extent, as shown in FIG. 9, while the body 110 and the first member 210 are elastically deformed. Therefore, according to the exemplary embodiment of the present disclosure, the ‘T’-shaped washer 100A may be refastened or repeatedly fastened and may thus be used semi-permanently. As a result, fastening force may be increased, assembly performance may be enhanced, manufacturing cost may be reduced, and assembly convenience may be improved.

Furthermore, in the securing structure 200 (200A or 200B) according to the exemplary embodiment of the present disclosure, because the pad 240 is disposed between the ‘T’-shaped washer 100 (250, 100A, or 100B) and the first member 210, watertightness between the ‘T’-shaped washer 100 (250, 100A, or 100B) and the first member 210 may be further enhanced. Furthermore, vibration performance or impact performance may be improved, and accordingly, the securing structure 200 (200A or 200B) according to the exemplary embodiment of the present disclosure may exhibit enhanced resistance to vibration or impact.

Furthermore, as shown in FIG. 1C, the body 110 of the ‘T’-shaped washer 100 according to the exemplary embodiment of the present disclosure includes the wedge-shaped guide portions 110L and 110R, the distance between which in the second direction gradually decreases in the downward direction thereof. Accordingly, the ‘T’-shaped washer 100 may exhibit improved assemblability. As shown in FIG. 4A and FIG. 4B, when the bolt 230 is initially inserted into the through-hole 110H, the bolt 230 may be aligned with the central axis XL by the guide portions 110L and 110R, whereby the straightness of the bolt 230 may be improved.

Furthermore, as shown in FIG. 4A, in the configuration in which the lower surface 110LS of the body 110 is disposed lower than the upper surface 220TS of the second member 220A, the first member 210 and the second member 220A may be aligned in the first direction by the body 110A.

Furthermore, if at least one of Equation 1 or Equation 2 above is satisfied, after the bolt 230 is completely fastened to the ‘T’-shaped washer 100A or 100B, the bolt 230 may be in press-fit engagement with the ‘T’-shaped washer 100A or 100B. As a result, loosening between the bolt 230, the ‘T’-shaped washer 100A or 100B, the first member 210, and the second member 220A or 220B may be prevented, and the fastening force (or residual fastening force) may be increased.

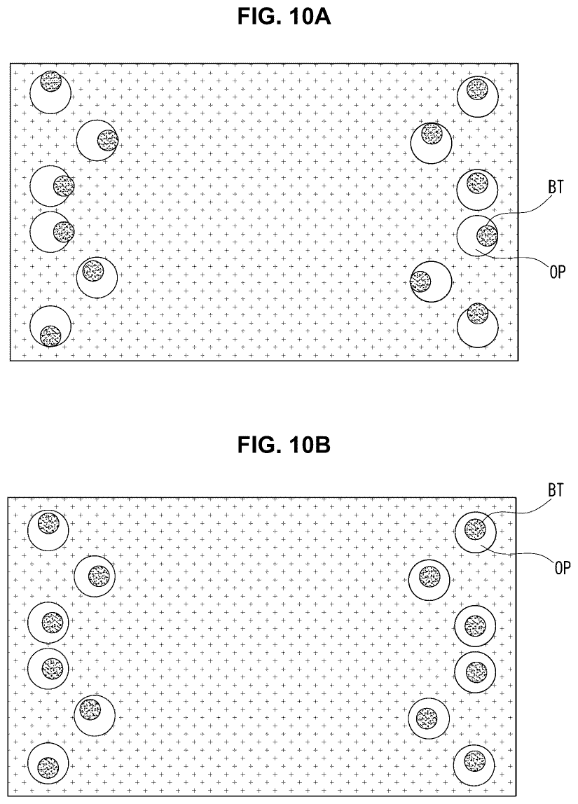

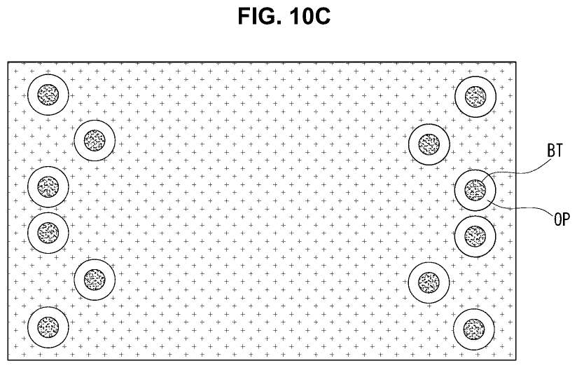

FIG. 10A, FIG. 10B and FIG. 10C are views showing an example of the fastening process in the fuel cell 300 shown in FIG. 6B. A plurality of bolts BT (230) and openings OP for insertion of the bolts BT (230) are illustrated in FIG. 10A, FIG. 10B and FIG. 10C.

At the initial stage in which the bolt BT (230) is fastened to the ‘T’-shaped washer 100A (see FIG. 5A), the bolt BT (230) is not aligned with the center portion of the opening OP, as shown in FIG. 10A. As the fastening of the bolt BT (230) to the ‘T’-shaped washer 100A proceeds (see FIG. 5B), the bolt BT (230) approaches the center portion of the opening OP, as shown in FIG. 10B. After the bolt BT (230) is completely fastened to the ‘T’-shaped washer 100A (see FIG. 5C), the bolt BT (230) is aligned with the center portion of the opening OP, as shown in FIG. 10C. As such, according to the exemplary embodiment of the present disclosure, the alignment of the bolt BT (230) is excellent. Accordingly, the size of the opening OP may be reduced compared to the comparative example. Furthermore, simultaneous fastening of a plurality of bolts using a robot or the like may be facilitated, thereby reducing capital investment and manufacturing cost.

As is apparent from the above description, the ‘T’-shaped washer, the securing structure including the same, and the fuel cell including the structure according to the exemplary embodiments of the present disclosure may exhibit enhanced watertightness and improved liquid ingress protection. Furthermore, fastening force may be increased, assembly performance may be enhanced, manufacturing cost may be reduced, and assembly convenience may be improved. Furthermore, vibration performance or impact performance may be improved, and accordingly, resistance to vibration or impact may be enhanced.

However, the effects achievable through the present disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

Furthermore, for any element or process that is not described in detail in any of the various exemplary embodiments of the present disclosure, reference may be made to the description of an element or a process including the same reference numeral in another exemplary embodiment of the present disclosure, unless otherwise specified.

While the present disclosure has been shown and described with reference to exemplary embodiments thereof, these embodiments are only provided for illustrative purposes, and do not restrict the present disclosure, and it will be apparent to those skilled in the art that various changes in form and detail may be made without departing from the essential characteristics of the exemplary embodiments set forth herein. For example, respective configurations set forth in the exemplary embodiments may be modified and applied. Furthermore, differences in such modifications and applications should be construed as falling within the scope of the present disclosure as defined by the appended claims.

What is claimed is:

1. A ‘T’-shaped washer, comprising:
a body including a through-hole;
a washer head disposed on a top portion of the body; and
a protruding portion protruding upwards from an upper surface of the washer head, the protruding portion having a planar annular shape surrounding the through-hole,
wherein at least part of the protruding portion is plastically deformed to a predetermined extent by an external force applied thereto to form a seal line.

2. The ‘T’-shaped washer of claim 1, wherein the body has an internal diameter decreasing in a downward direction thereof and is elastically deformed by the external force so that the internal diameter increases.

3. The ‘T’-shaped washer of claim 2, wherein the protruding portion is plastically deformed so that an external boundary of the seal line extends in a direction away from a central axis of the ‘T’-shaped washer.

4. The ‘T’-shaped washer of claim 1, wherein the protruding portion has a cross-sectional shape including at least one step.

5. The ‘T’-shaped washer of claim 1, wherein the protruding portion includes:
an internal inclined surface inclined at a first angle with respect to the upper surface of the washer head; and
an external inclined surface inclined at a second angle greater than the first angle with respect to the upper surface of the washer head, the external inclined surface forming an upwardly protruding shape together with the internal inclined surface.

6. A securing structure, comprising:
a ‘T’-shaped washer configured to be inserted into at least one of a first member or a second member overlapping each other in a first direction; and
a bolt penetrating the ‘T’-shaped washer to secure the first member and the second member,
wherein the ‘T’-shaped washer includes:
a body including a through-hole;
a washer head disposed on a top portion of the body; and
a protruding portion protruding upwards from an upper surface of the washer head, the protruding portion having a planar annular shape surrounding the through-hole, and
wherein at least part of the protruding portion is plastically deformed to a predetermined extent by an external force applied thereto to form a seal line.

7. The securing structure of claim 6, wherein the ‘T’-shaped washer is formed of a material having yield strength lower than yield strength of each of the bolt and the first member.

8. The securing structure of claim 6, wherein the body has an internal diameter decreasing in a downward direction and is elastically deformed by the external force so that the internal diameter increases.

9. The securing structure of claim 8,
wherein the bolt is a flange bolt including a bolt head and a bolt washer disposed under the bolt head, and
wherein at least a portion of a lower surface of the bolt washer contacts with the protruding portion to form the seal line.

10. The securing structure of claim 6, wherein an initial contact area between the protruding portion and the bolt is determined as follows:
$$\frac{FAF}{YS} > IAR$$
where FAF represents axial fastening force of the bolt, YS represents yield strength of the protruding portion, and IAR represents the initial contact area.

11. The securing structure of claim 6, wherein the first member includes:
a first upper portion including a first through-hole and a first receiving recess,
wherein the first receiving recess is disposed to surround the first through-hole and to receive and support at least a portion of the washer head, and
wherein at least a portion of the body is inserted into the first through-hole, the bolt penetrating the first through-hole.

12. The securing structure of claim 11, wherein the second member includes a second through-hole in fluidical communication with the first through-hole in the first member, the bolt penetrating the second through-hole.

13. The securing structure of claim 12, wherein the body includes a lower surface disposed higher than an upper surface of the second member.

14. The securing structure of claim 12, wherein the body includes a lower surface disposed lower than an upper surface of the second member.

15. The securing structure of claim 14, wherein the second member further includes a second upper portion including a second receiving recess disposed to surround the second through-hole and to receive a lower end of the body.

16. The securing structure of claim 15, wherein, in a non-elastically deformed state of the body, an external diameter of the body is less than a diameter of the second receiving recess.

17. The securing structure of claim 15, wherein an external diameter of the body is greater than a diameter of the second receiving recess based on the bolt securing the first and second members due to elastic deformation of the body.

18. The securing structure of claim 15, wherein, based on the bolt securing the first and second members due to elastic deformation of the body, a first width of the bolt in a second direction intersecting the first direction, a second width of a portion of the body located on one side of the through-hole in the second direction, and a diameter of the second receiving recess are determined as follows:
W1+W2>D2
where W1 represents the first width, W2 represents the second width, and D2 represents the diameter of the second receiving recess.

19. A fuel cell, comprising:
a cell stack including a plurality of unit cells and end plates disposed at respective end portions of each of the plurality of unit cells;
a manifold block configured to supply hydrogen and air to the cell stack;
a side cover configured to supply coolant to the cell stack;
a ‘T’-shaped washer inserted into at least one of a first member or a second member, the first member being one of the manifold block and the side cover, the second member being one of the end plates; and
a bolt penetrating the ‘T’-shaped washer to secure the first member and the second member,
wherein the ‘T’-shaped washer includes:
a body including a through-hole;
a washer head disposed on a top portion of the body; and
a protruding portion protruding upwards from an upper surface of the washer head, the protruding portion having a planar annular shape surrounding the through-hole, and
wherein at least part of the protruding portion is plastically deformed to a predetermined extent by an external force applied thereto to form a seal line.

20. A fuel cell, comprising:
a cell stack including a plurality of unit cells and first and second end plates disposed at respective end portions of each of the plurality of unit cells;
a manifold block or a side cover disposed on the first end plate;
an enclosure disposed to surround the second end plate and a side portion of the cell stack;
a ‘T’-shaped washer inserted into at least one of the first member or the second member; and
a bolt penetrating the ‘T’-shaped washer to secure the first member and the second member,
wherein the ‘T’-shaped washer includes:
a body including a through-hole;
a washer head disposed on a top portion of the body; and
a protruding portion protruding upwards from an upper surface of the washer head, the protruding portion having a planar annular shape surrounding the through-hole,
wherein at least part of the protruding portion is plastically deformed to a predetermined extent by an external force applied thereto to form a seal line, and
wherein the first member is the manifold block or the side cover and the second member is the first end plate, or the first member is the enclosure and the second member is the second end plate.
